(19) United States
(12) Patent Application Publication
(10) Pub. No.: US 2007/0216630 A1
(43) Pub. Date: Sep. 20, 2007

(54) METHOD FOR TRANSMITTING DATA SIGNALS AND CONTROL SIGNALS USING A SIGNAL DATA BUS AND RELATED APPARATUS

(76) Inventor: Chien-Chuan Liao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/383,760

(22) Filed: May 17, 2006

(30) Foreign Application Priority Data
Mar. 15, 2006 (TW) 095108833

(51) Int. Cl. G09G 3/36

(52) U.S. Cl. 345/100

(57) ABSTRACT

A display device includes a timing controller, a plurality of source drivers, and an interface. Data signals and control signals generated by the timing controller are embedded and transmitted to the source drivers via a data bus of the interface. Decoders of the source drivers can then generate corresponding data signals and control signals by decoding the embedded signals.

### BACKGROUND OF THE INVENTION

1. Field of the Invention

The present invention relates to a method for transmitting data signals and control signals and related apparatus, and more particularly, to a method for transmitting data signals and control signals using a signal data bus and related apparatus.

2. Description of the Prior Art

Liquid crystal display (LCD) devices are flat panel displays characterized by thin appearance, low radiation and low power consumption. LCD devices have gradually replaced traditional cathode ray tube (CRT) displays, and been widely applied in various electronic products such as notebook computers, personal digital assistants (PDAs), flat panel televisions, or mobile phones.

An LCD device usually includes an LCD panel, a timing controller, a gate driver, and a source driver. A plurality of parallel data lines and a plurality of parallel scan lines intersecting the data lines are disposed on the LCD panel. A pixel circuit is disposed at each intersection of the data lines and the scan lines. Therefore, the LCD panel includes a matrix array of pixel circuits. The timing controller generates data signals corresponding to display images, together with control signals and timing signals for driving the LCD panel. The gate driver generates scan signals for turning on/off the pixel circuits, and the source driver generates driving signals based on the data signals, the control signals and the timing signals.

Each pixel circuit of the LCD panel includes a thin film transistor (TFT) and a pixel electrode. After receiving the scan signals from the gate driver and the driving signals from the source driver, the pixel circuits can display images of different grey scales by controlling the rotation of the liquid crystal molecules. For displaying images correctly, various signals are transmitted from the timing controller to the source driver via an interface. Common interfaces used in an LCD device include transistor-transistor logic (TTL) interfaces, reduced swing differential signal (RSDS) interfaces, low voltage differential signal (LVDS) interfaces, and mini low voltage differential signal (mini-LVDS) interfaces, etc.

Reference is made to FIG. 1 for a diagram illustrating a prior art LCD device 10 using an RSDS interface. The LCD device 10 includes an LCD panel 12, a timing controller 14, a plurality of source drivers CD₁-CDₙ, a plurality of gate drivers 16, a data bus 102, a clock bus 104, and signal lines 111-113. The timing controller 14 outputs data signals DATA corresponding to images to be displayed by the LCD panel 12, together with timing signals CLK and control signals for driving the LCD panel 12. The control signals include data load signals LD, polarity signals POL, and start pulse signals SP. In the prior art LCD device 10, the data signals DATA, the timing signals CLK and the control signals LD, POL, and SP are transmitted separately. Each source driver of the LCD device 10 receives the data signals DATA, the clock signals CLK, the control signals LD, and the control signals POL via the data bus 102, the clock bus 104, the signal line 111, and the signal line 112, respectively. The source driver CD₁ receives the control signals SP via the signal line 113, and the source drivers CD₁-CDₙ₋₁ sequentially output control signals SP₁-SPₙ₋₁ to the next corresponding source drivers CD₂-CDₙ, respectively. In the prior art LCD device 10, multiple signal lines are required for properly transmitting different control signals from the timing controller 14 to the source drivers CD₁-CDₙ. As a result, the circuit layout of the prior art LCD device 10 is very complicated.

With increasing demand for larger-sized applications, the sizes of LCD panels also grow larger and more source drivers are required for providing sufficient driving capability. As a result, the prior art LCD device 10 need more signals lines, which further complicates the circuit layout. Also, since the data signals DATA, the timing signals CLK and the control signals LD, POL, and SP are transmitted separately, signal transmission paths from the timing controller 14 to different source drivers vary accordingly. Different source drivers receive signals having different degrees of signal skew. Thus, the display quality of the LCD device 10 is largely affected.

### SUMMARY OF THE INVENTION

The claimed invention provides a display device capable of transmitting data signals and control signals using a signal data bus includes a timing controller for outputting data signals, control signals and timing signals; a plurality of source drivers each including a decoder for decoding data received from the timing controller, thereby generating control signals for driving a display panel of the display device and data signals corresponding to display images; and an interface coupled between the timing controller and the plurality of source drivers including a data bus for receiving the data and control signals outputted by the timing controller, converting the received data and control signals into a corresponding first signal, and transmitting the first signal to the decoder of each source driver.

The claimed invention further provides a method for transmitting data signals and control signals using a signal data bus includes transmitting a first signal corresponding to control signals of a display device to a plurality of source drivers of the display device via a data bus; and transmitting a second signal corresponding to data signals of display images to the plurality of source drivers of the display device via the data bus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art LCD device.

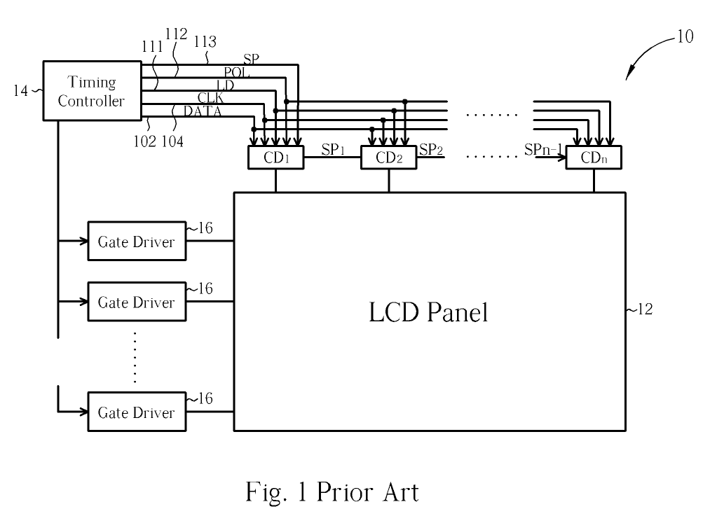

FIG. 2 is a diagram illustrating an LCD device according to the present invention.

FIG. 3 is a signal diagram illustrating a method for transmitting data and control signals using a single RSDS data bus according to a first embodiment of the present invention.

FIG. 4 is a signal diagram illustrating a method for transmitting data and control signals using a single RSDS data bus according to a second embodiment of the present invention.

### DETAILED DESCRIPTION

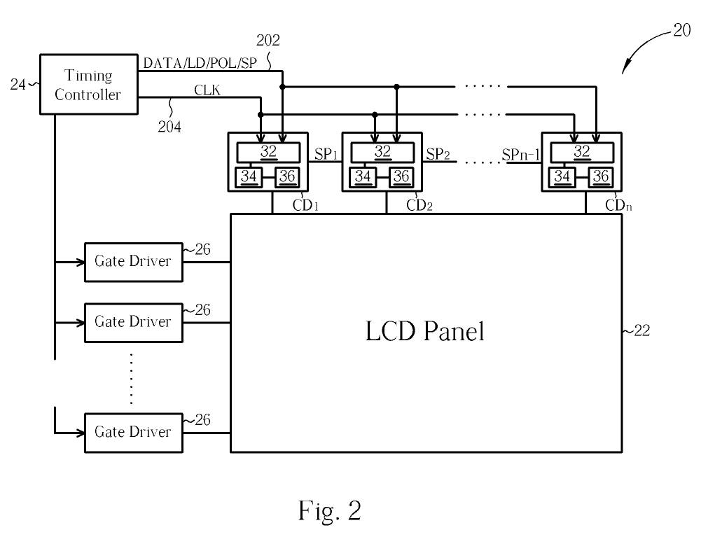

Reference is made to FIG. 2 for a diagram illustrating an LCD device 20 according to the present invention. The LCD device 20 includes an LCD panel 22, a timing controller 24, a plurality of source drivers CD₁-CDₙ, a plurality of gate drivers 26, a data bus 202, and a clock bus 204. The timing controller 24 outputs data signals DATA corresponding to images to be displayed by the LCD panel 22, together with timing signals CLK and control signals for driving the LCD panel 22. The control signals include data load signals LD, polarity signals POL, and start pulse signals SP. In the LCD device 20 of the present invention, the data signals DATA, the timing signals CLK and the control signals LD, POL, and SP are transmitted via the data bus 202. The clock signals CLK are transmitted from the timing controller 24 to the source drivers CD₁-CDₙ. The control signals LD, POL, and SP are embedded into the data signals DATA and the embedded signals are transmitted to the source driver CD₁. The control signals LD and POL are embedded into the data signals DATA and the embedded signals are transmitted to the source drivers CD₂-CDₙ₋₁. The source drivers CD₁-CDₙ₋₁ sequentially output control signals SP₁-SPₙ₋₁ to the next corresponding source drivers CD₂-CDₙ, respectively.

Also, each source driver includes a data latch 32, a decoder 34, and an output buffer 36. The LCD device 20 stores data transmitted via the data bus 202 in a corresponding data latch 32, which then transmits the stored data to the decoder 34. The decoder 34 generates driving signals for the LCD panel 22 by decoding data received from the data latch 32. The driving signals are outputted from the buffer 36 to the LCD panel 22 so that each pixel circuit can display images of corresponding grey scales. In the present invention, the control signals are embedded into the data signals DATA and transmitted to the source drivers CD₁-CDₙ via the data bus 202. The decoders 34 of the source drivers CD₁-CDₙ can then generate data corresponding to the original data signals DATA and the original control signals LD, POL and SP by decoding the embedded signals. In the present invention, only two data busses are required for transmitting the data, clock and control signals. Therefore, the circuit layout of the LCD device 20 can be simplified.

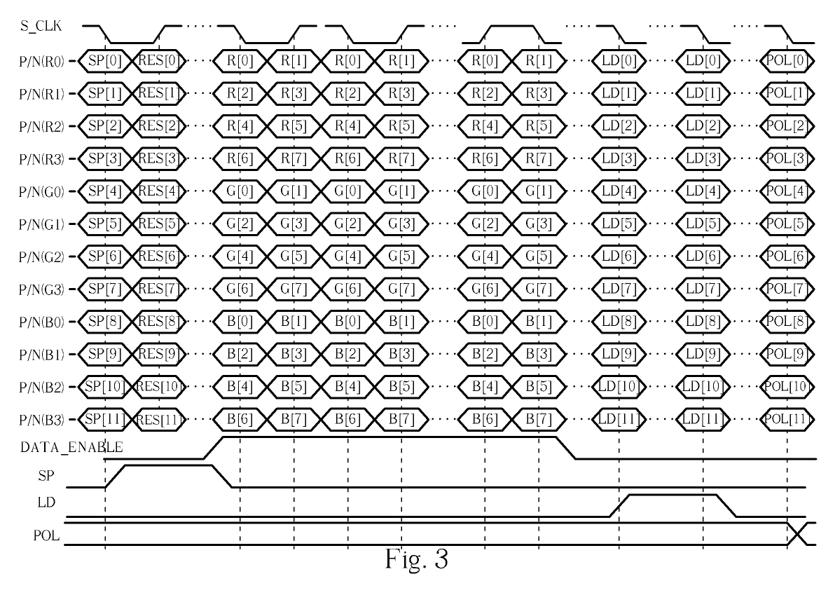

Reference is made to FIG. 3 for a signal diagram illustrating a method for transmitting data and control signals using a single RSDS data bus according to a first embodiment of the present invention. An RSDS data bus can transmit a 12-bit data at a time. In FIG. 3, P/N(R0)-P/N(R3), P/N(G0)-P/N(G3), and P/N(B0)-P/N(B3) represent the 12 bits of the data, and S_CLK represents the clock signals CLK. Data can be accessed at the rising edges and falling edges of S_CLK.

In the first embodiment of the present invention, each type of control signal is provided with a corresponding data code. The data codes of the control signals are then embedded into data blanking periods of the data signals, and transmitted to the source drivers CD₁-CDₙ via the data bus 202. The decoders 32 of the source drivers CD₁-CDₙ can then generate corresponding control signals based on the embedded signals. In FIG. 3, DATA_ENABLE, SP, LD, and POL respectively represent data enable signals, start pulse signals, data load signals and polarity signals obtained by decoding the embedded signals.

First, after resetting the system, the timing controller 24 holds the RSDS data bus at a predetermined state (such as 0x000) in which no control signal is generated by the decoders 32 of the source drivers CD₁-CDₙ. Next, the timing controller 24 sequentially outputs a first data code SP[0:11] corresponding the start pulse signals and a second data code RES[0:11] corresponding the horizontal resolution of the LCD panel 22 to corresponding source drivers. The decoders 32 of the source drivers CD₁-CDₙ generate the start pulse signals SP and the data enable signals DATA_ENABLE, thereby providing the source drivers CD₁-CDₙ with information related to the beginning of image data, the end of image data and panel resolution. Then the timing controller 24 outputs data signals R[0:7], G[0:7], and B[0:7] corresponding to the display images. After transmitting the data signals R[0:7], G[0:7], and B[0:7] to corresponding source drivers CD₁-CDₙ, the timing controller 24 can then output data codes of other control signals via the RSDS data bus, such as data codes LD[0:11] and POL[0:11]. The data code LD[0:11] contains information about when to send image data to the LCD panel 22, and the data code POL[0:11] contains polarity information of the image data sent to the LCD panel 22. Based on the data codes LD[0:11] and POL[0:11], the decoders 32 of the source drivers CD₁-CDₙ can generate the control signals LD and POL, so that the source drivers CD₁-CDₙ can provide the LCD panel 22 with driving signals having correct polarity at the correct time.

In the first embodiment of the present invention, the decoders decode the data received from the timing controller so as to provide the source drivers with data signals corresponding to display images and control signals corresponding to the beginning of image data, the end of image data, panel resolution or the output time of image data. In the present invention, since the data and control signal are embedded and transmitted via the same data bus, no extra signal lines are required. Therefore, the LCD devices according to the present invention have simple circuit layout.

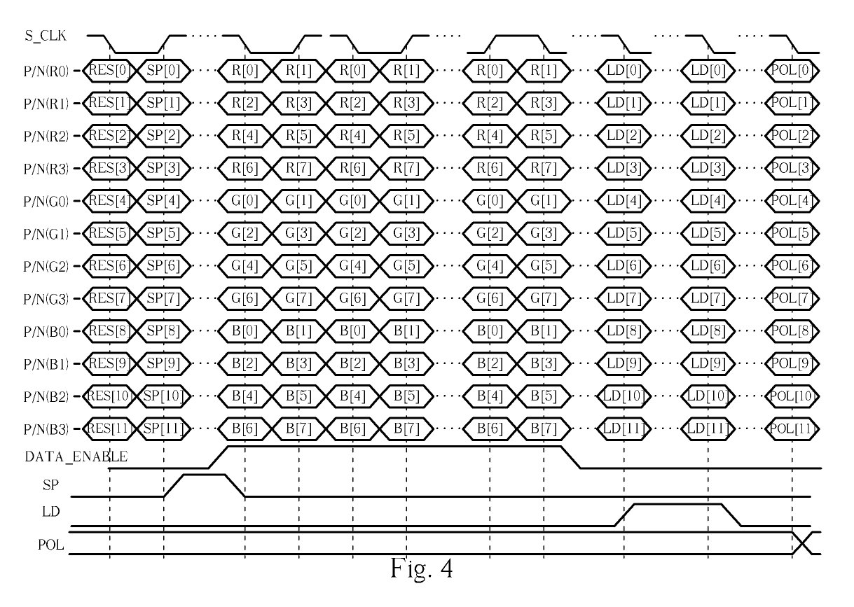

Reference is made to FIG. 4 for a signal diagram illustrating a method for transmitting data and control signals using a single RSDS data bus according to a second embodiment of the present invention. An RSDS data bus can transmit a 12-bit data at a time. In FIG. 4, P/N(R0)-P/N(R3), P/N(G0)-P/N(G3), and P/N(B0)-P/N(B3) represent the 12 bits of the data, and S_CLK represents the clock signals CLK. Data can be accessed at the rising edges and falling edges of S_CLK.

In the second embodiment of the present invention, each type of control signal is also provided with a corresponding data code. The data codes of the control signals are then embedded into the data blanking periods of the data signals, and transmitted to the source drivers CD₁-CDₙ via the data bus 202. The decoders 32 of the source drivers CD₁-CDₙ can then generate corresponding control signals based on the embedded signals. In FIG. 4, DATA_ENABLE, SP, LD, and POL respectively represent data enable signals, start pulse signals, data load signals and polarity signals obtained by decoding the embedded signals.

The second embodiment differs from the first embodiment in the output sequence of the data codes SP[0:11] and RES[0:11]. First, after resetting the system, the timing controller 24 holds the RSDS data bus at a predetermined state (such as 0x000) in which no control signal is generated by the decoders 32 of the source drivers CD₁-CDₙ. Next, the timing controller 24 sequentially outputs the data code RES[0:11] corresponding the horizontal resolution of the LCD panel and the data code SP[0:11] corresponding the start pulse signals to corresponding source drivers. The decoders 32 of the source drivers CD₁-CDₙ generate the start pulse signals SP and the data enable signals DATA_ENABLE, thereby providing the source drivers CD₁-CDₙ with information related to the beginning of image data, the end of image data and panel resolution. Then the timing controller 24 outputs data signals R[0:7], G[0:7], and B[0:7] corresponding to the display images. After transmitting the data signals R[0:7], G[0:7], and B[0:7] to corresponding source drivers CD₁-CDₙ, the timing controller 24 can then output data codes of other control signals via the RSDS data bus, such as data codes LD[0:11] and POL[0:11]. The data code LD[0:11] contains information about when to send image data to the LCD panel 22, and the data code POL[0:11] contains polarity information of the image data sent to the LCD panel 22. Based on the data codes LD[0:11] and POL[0:11], the decoders 32 of the source drivers CD₁-CDₙ can generate the control signals LD and POL, so that the source drivers CD₁-CDₙ can provide the LCD panel 22 with driving signals having correct polarity at the correct time.

In the embodiments shown in FIGS. 3 and 4, an RSDS data bus is used for illustrating the present invention. However, the present invention can also be applied to other interfaces, such as LVDS interfaces or mini-LVDS interfaces. Also, the data bus 202 and the clock bus can include multi-drop data busses.

In the present invention, the data and control signal are embedded and transmitted via the same data bus. The decoders decode the embedded data received from the timing controller so as to provide the source drivers with data signals corresponding to display images and control signals corresponding to the beginning of image data, the end of image data, panel resolution or the output time of image data. Since the data and control signal are embedded and transmitted via the same data bus, no extra signal lines are required. Therefore, the LCD devices according to the present invention have simple circuit layout.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device capable of transmitting data signals and control signals using a signal data bus comprising:
a timing controller for outputting data signals, control signals and timing signals;
a plurality of source drivers each including a decoder for decoding data received from the timing controller, thereby generating control signals for driving a display panel of the display device and data signals corresponding to display images; and
an interface coupled between the timing controller and the plurality of source drivers including a data bus for receiving the data and control signals outputted by the timing controller, converting the received data and control signals into a corresponding first signal, and transmitting the first signal to the decoder of each source driver.

2. The display device of claim 1 wherein the data bus includes a multi-drop data bus.

3. The display device of claim 1 wherein the interface further includes a clock bus coupled between the timing controller and the plurality of source drivers for receiving the timing signals outputted by the timing controller, converting the received timing signals into a corresponding second signal, and transmitting the second signal to the plurality of source drivers.

4. The display device of claim 3 wherein the clock bus includes a multi-drop data bus.

5. The display device of claim 1 wherein each source driver further includes a data latch coupled between a corresponding decoder and the data bus.

6. The display device of claim 5 wherein each source driver further includes an output buffer coupled to a corresponding decoder.

7. The display device of claim 1 wherein the interface includes a transistor-transistor logic (TTL) interface, a reduced swing differential signal (RSDS) interface, a low voltage differential signal (LVDS) interface, or a mini low voltage differential signal (mini-LVDS) interface.

8. A method for transmitting data signals and control signals using a signal data bus comprising:
transmitting a first signal corresponding to control signals of a display device to a plurality of source drivers of the display device via a data bus; and
transmitting a second signal corresponding to data signals of display images to the plurality of source drivers of the display device via the data bus.

9. The method of claim 8 further comprising:
embedding the first signal into data blanking periods of the second signal.

10. The method of claim 8 further comprising:
a timing controller generating the control signals of the display device and the data signals of display images.

11. The method of claim 8 further comprising:
the data bus generating the first signal based on the control signals of the display device; and
the data bus generating the second signal based on the data signals of display images.

12. The method of claim 8 further comprising:
decoding the first and second signals for generating data corresponding to the control signals of the display device and the data signals of display images.

13. The method of claim 12 further comprising:
outputting the data generating by decoding the first and second signals.

14. The method of claim 8 further comprising:
transmitting timing signals of the display device to the plurality of source drivers of the display device via a clock bus.
